(19) United States
(12) Patent Application Publication
(10) Pub. No.: US 2024/0232452 A9
(43) Pub. Date: Jul. 11, 2024

(54) SYSTEM AND METHOD FOR MODELLING AND POSITIONING PARTS IN A MECHANICAL COMPONENT DESIGN

(71) Applicant: Siemens Industry Software Inc., Plano, TX (US)

(72) Inventor: Howard Mattson, Cambridge, Cambridgeshire (GB)

(21) Appl. No.: 18/278,781

(22) PCT Filed: Feb. 26, 2021
(86) PCT No.: PCT/US2021/019967

§ 371 Date: Aug. 24, 2023

(51) Int. Cl. G06F 30/17

(52) U.S. Cl. CPC G06F 30/17

(57) ABSTRACT

A method of modifying instances of at least one part P including at least one entity e in a mechanical component design, is disclosed. A first part P₁ has a local co-ordinate frame F and includes at least one entity eᵢ. A transform T₁ applied to the part P₁ obtains a part instance P₁T₁ having an instance co-ordinate frame F₁ in a common global space. At least one entity e₁ in the part instance P₁T₁ is then marked as a positioning entity pe₁ and grouped rigidly with the instance co-ordinate frame F₁. Causing a positioning entity pe₁ to move in the instance co-ordinate frame F₁ causes all positioning entities pe₁ in the instance co-ordinate frame F₁ to move rigidly with the instance co-ordinate frame F₁ and any unmarked entities e₁ to move independently of the rigid grouping of positioning entities pe₁.

### CROSS REFERENCE TO RELATED APPLICATIONS

This present patent document is a § 371 nationalization of PCT Application Serial Number PCT/US2021/019967, filed Feb. 26, 2021, designating the United States which is hereby incorporated in its entirety by reference.

### FIELD

Embodiments relate to a computer-implemented method of modifying instances of at least one part P in a mechanical component design, wherein each part P includes at least one entity e, such as a face, vertex, or other feature.

### BACKGROUND

When designing a component including a plurality of parts in a computer-aided design (CAD) environment a designer often needs to change aspects of the design during the design process. For example, it may be necessary to change the shape of one or more parts (known as “part modelling”) or to change the position of one or more instances of parts (known as “part positioning”). Typically, however, conventional CAD systems do not offer the ability to be able to modify both part shape and instance positioning at the same time. This results in a designer performing any modifications to the parts or part instances in a staged manner, rather than in a single operation. Staging the modification is both time-consuming and awkward, and may be prone to errors, particularly where shape and position are tightly coupled across multiple parts. A trial-and-error approach may be used, where multiple iterations of shape change followed by position adjustment, or vice versa are carried out until a solution with all components having the correct shape and position is obtained. At each stage of this process certain solving conditions must be broken in order to make the first change (shape). Making the second change (position) is an attempt to re-establish these conditions, that may or may not be successful.

FIG. 1 is a schematic illustration of a prior art two-stage process for modelling a part and instances of a part. FIG. 1a depicts a part P including a simple component 1 having three through holes 2a, 2b, 2c aligned with three holes 3a, 3b, 3c in a base plate 4. FIG. 1a (i) represents a perspective view from above, and FIG. 1a (ii) represents a perspective view from below. Initially, the component 1 is positioned at the right-hand end of the base plate 4, as illustrated in FIG. 1b (i). Taking the two-stage process outlined above where the first stage is to move the component 1 to the left-hand end of the base plate 4, there is an intermediate stage, as illustrated in FIG. 1b (ii) where the association between the component 1 and the through holes 2a, 2b, 2c to the holes 3a, 3b, 3c in the base plate 4 is lost. The second stage, possibly by solving explicit constraints, attempts to move the holes 3a, 3b, 3c in the base plate 4 to match up with the through holes 2a, 2b, 2c in the component 1, as shown in FIG. 1b (iii). Alternatively, the designer may undertake the two-stage process in the opposite order, as illustrated in FIG. 1c. Starting from the same initial position as illustrated in FIG. 1c (i), the first stage this time is to move the through holes 3a, 3b, 3c to the left-hand end of the base plate 4, resulting in an intermediate position as in FIG. 1c (ii) where again the association between the holes 3a, 3b, 3c in the base plate 4 and the through holes 2a, 2b, 2c in the component 1 is lost. Again, finally, the second stage is to try to re-align the through holes 2a, 2b, 2c in the component 1 and the holes 3a, 3b, 3c in the base plate 4 by moving the component 1 to the left-hand end of the base plate 4, possibly by solving explicit constraints. The artificial intermediate stages of FIGS. 1b (ii) and 1c (ii) introduce the possibility of failure of the second stage of the process, regardless of the order the stages are taken in. The failure of the second stage leaves the model in an inconsistent state. Even if the second stage succeeds, the process is involved and lacks the intuitive nature of other types of modelling processes. In addition, a designer is unable to immediately explore and assess the impact of design changes, that lessens the operability of the process and the ability to create accurate, reproducible, and practicable results. There is therefore a need for a method in which it is possible to remove the intermediate stage and guarantee the ease of use and accuracy of the design process.

### BRIEF SUMMARY AND DESCRIPTION

The scope of the embodiments is defined solely by the appended claims and is not affected to any degree by the statements within this summary. The present embodiments may obviate one or more of the drawbacks or limitations in the related art.

Embodiments provide, in a first aspect, a computer-implemented method of modifying instances of at least one part P in a mechanical component design, wherein each part P includes at least one entity e, the method including the steps of: obtaining, in its local space, a local instance of a first part P₁ having a local co-ordinate frame F, wherein the part P₁ includes at least one entity eᵢ; applying a transform T₁ to the part P₁ to obtain a part instance P₁T₁ having an instance co-ordinate frame F₁ in a common global space, wherein the entity eᵢ is transformed to a corresponding entity e₁ in the part instance P₁T₁; marking at least one entity e₁ in the part instance P₁T₁ as a positioning entity pe₁; and grouping the marked positioning entity pe₁ rigidly with the instance co-ordinate frame F₁, wherein any unmarked entities e₁ are not grouped rigidly with the instance co-ordinate frame F₁, such that causing a positioning entity pe₁ to move in the instance co-ordinate frame F₁ causes all positioning entities pe₁ in the instance co-ordinate frame F₁ to move rigidly with the instance co-ordinate frame F₁ and all of the unmarked entities e₁ to move independently of the rigid grouping of positioning entities pe₁.

By grouping entities within their frame of reference rigidly, and enabling other entities to move independently within their frames of reference it is possible for a designer to carry out both positioning and modelling actions on parts and/or instances of parts in a model structure without the need for the intermediate stage of the prior art. Removing this stage has a number of benefits, including the improved reliability and accuracy of the design process and a reduction in the time taken for designs to be completed (due to the removal not just of the intermediate stages but the reduction in the iterations necessary to obtain a satisfactory result).

The method may further include the step of: repeating the steps above for a second part P₂ having at least one entity e₂, such that moving positioning entities pe₁ in either the first part P₁ in its instance co-ordinate frame F₁ or the second part P₂ in its instance co-ordinate frame F₂ causes all of the other positioning entities pe₁ in their respective co-ordinate frames F₁, F₂ to move together in their respective rigid groupings.

The method may further include the step of: applying a transform T₂ to the part P₁ to obtain a part instance P₁T₂ having an instance co-ordinate frame F₂₁ in a common global space, wherein the entity eᵢ is transformed to a corresponding entity e₂₁ in the part instance P₁T₂.

Any entities e₁, e₂, e₂₁ that are not marked as positioning entities pe₁, pe₂, pe₂₁ in the instance co-ordinate frame F₁, F₂ or F₂₁, may be marked as modelling entities me₁, me₂, me₂₁. Corresponding unmarked entities eᵢ in the local co-ordinate frame F are also marked as modelling entities meᵢ. In the modelling entities meᵢ, me₁, me₂, me₂₁ are not grouped rigidly with their respective co-ordinate frames F, F₁, F₂ or F₂₁.

Causing one of the modelling entities meᵢ in the local co-ordinate frame F to move or causing one of the modelling entities me₁, me₂, me₂₁ in their respective instance co-ordinate frames F₁, F₂, F₂₁ to move causes all instances of the same entity meᵢ, me₁, me₂, me₂₁ to move in their respective co-ordinate frames F, F₁, F₂, F₂₁. In this situation, any entity eᵢ, e₁, e₂, e₂₁ connected to the moving modelling entity meᵢ, me₁, me₂, me₂₁ is modified to remain connected to the moving modelling entity meᵢ, me₁, me₂, me₂₁.

The positioning entities pe₁, pe₂, pe₂₁ and the modelling entities meᵢ, me₁, me₂, me₂₁ may be in different instances of the same part.

The assembly positioning of the parts P may take place in the common global space. The parts P may be sub-assemblies in an assembly tree.

The instance conditions maintained during positioning and modelling may be defined as:

T₁(P₁·eᵢ)=P₁T₁e₁

T₂(P₁·eᵢ)=P₁T₂e₂

Implied symmetry and/or inherent entity relationships may be maintained during positioning and modelling.

The entities e in a part P may either all be marked as positioning entities pe or all be marked as modelling entities me. All the entities e are changed between being marked as positioning entities pe or all marked as modelling entities me simultaneously.

Embodiments further provide, in a second aspect, a data processing system including a processor configured to carry out the method above.

Embodiments further provide, in a third aspect, a computer program including instructions that, when the program is executed by a computer, cause the computer to carry out the steps of the method above.

### BRIEF DESCRIPTION OF THE FIGURES

FIG. 1a (i) is a schematic perspective view of a part P from above according to an embodiment.

FIG. 1a (ii) is a schematic perspective view of the part P from below.

FIG. 1b (i) is a schematic perspective view of the part P in a first stage of a first design process.

FIG. 1b (ii) is a schematic perspective view of the part P in an intermediate stage of a first design process.

FIG. 1b (iii) is a schematic perspective view of the part P in a second stage of a first design process.

FIG. 1c (i) is a schematic perspective view of the part P in a first stage of a second design process.

FIG. 1c (ii) is a schematic perspective view of the part P in an intermediate stage of a second design process.

FIG. 1c (iii) is a schematic perspective view of the part P in a second stage of a second design process.

FIG. 2 is a schematic illustration of the relationship between a part P in local space and instances of the part P in a common global space according to an embodiment.

FIG. 3 is a flow-chart illustrating a method of modifying instances of at least one part P in a mechanical component design in accordance with an embodiment.

FIG. 4 is a schematic illustration of a modelling action in relation to the part P illustrated in FIG. 2 according to an embodiment.

FIG. 5 is a is a schematic illustration of a positioning action in relation to the part P illustrated in FIG. 2 according to an embodiment.

FIG. 6 is a schematic perspective illustration of a positioning action according to an embodiment.

FIG. 7 is a schematic perspective illustration of a modelling action according to an embodiment.

FIG. 8 is a schematic perspective illustration of a positioning action and a modelling action in the same part in a model according to an embodiment.

FIG. 9 is a schematic perspective illustration of a positioning action and a modelling action in different parts of a model according to an embodiment.

FIG. 10 is a schematic perspective illustration of a further positioning action and a modelling action in different parts of a model according to an embodiment.

FIG. 11 is a schematic perspective illustration of a further positioning action and a modelling action in different parts of a model according to an embodiment.

FIG. 12 a schematic perspective illustration of the modification of different parts of a model according to an embodiment.

FIG. 13 a flow-chart illustrating an implementation of embodiments within a solver.

### DETAILED DESCRIPTION

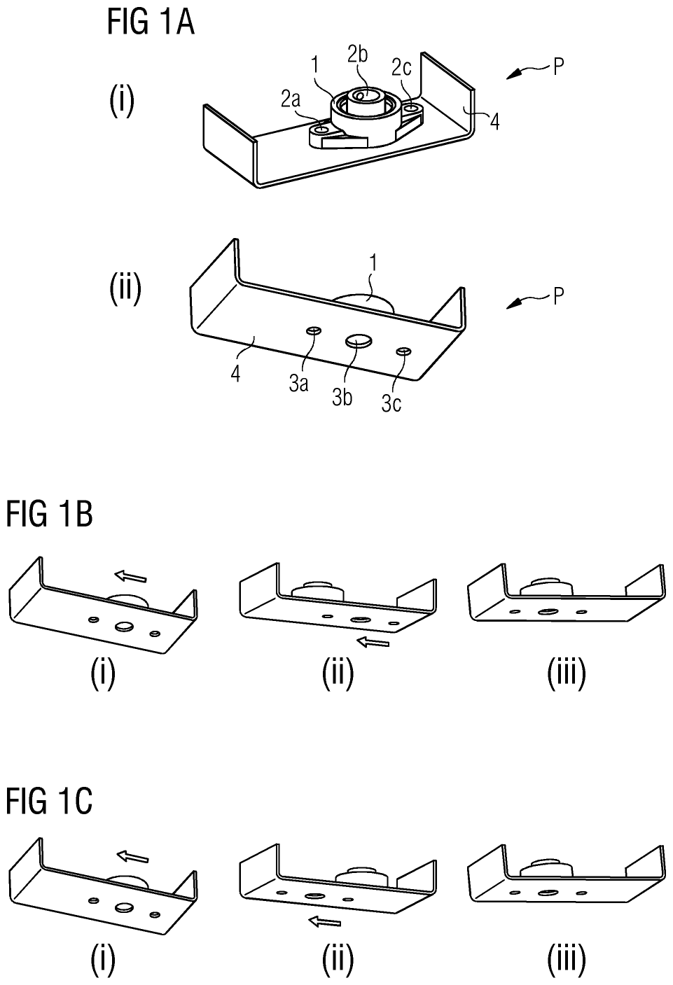

Embodiments provide a designer with the ability to change both the shape of a part and the position of a part instance at the same time, without the need for the intermediate stage shown in FIG. 1. In order to provide a method for a designer, embodiments provide a computer-implemented method of modifying instances of at least one part P in a mechanical component design. Each part P includes at least one entity e, where the entity may be a face, vertex or other feature of the design. Initially, the method includes the step of obtaining, in its local space, a local instance of a first part P₁ having a local co-ordinate frame F. The part P₁ includes at least one entity eᵢ. A transform T₁ is then applied to the part P₁ to obtain a part instance P₁T₁ having an instance co-ordinate frame F₁ in a common global space. This means that the entity eᵢ is transformed to a corresponding entity e₁ in the part instance P₁T₁. At least one entity e₁ in the part instance P₁T₁ is then marked as a positioning entity pe₁ and grouped rigidly with the instance co-ordinate frame F₁. Any unmarked entities e₁ are not grouped rigidly with the instance co-ordinate frame F₁. The grouping step means that causing a positioning entity pe₁ to move in the instance co-ordinate frame F₁ causes all positioning entities pe₁ in the instance co-ordinate frame F₁ to move rigidly with the instance co-ordinate frame F₁ and all of the unmarked entities e₁ to move independently of the rigid grouping of positioning entities pe₁. This enables the component 1 and the holes in the base plate 4 in FIG. 1 to move simultaneously, maintaining the association between the through holes 2a, 2b, 2c in the component 1 and the holes 3a, 3b, 3c in the base plate 4. In addition, it is also possible to change the shape of one part and move the position of instances of the same or other parts, as will now be explained in more detail below. In the following description the term “modelling” is used to describe actions that change the shape of a part or a part instance and the term “positioning” is used to describe actions that change the position of a part instance.

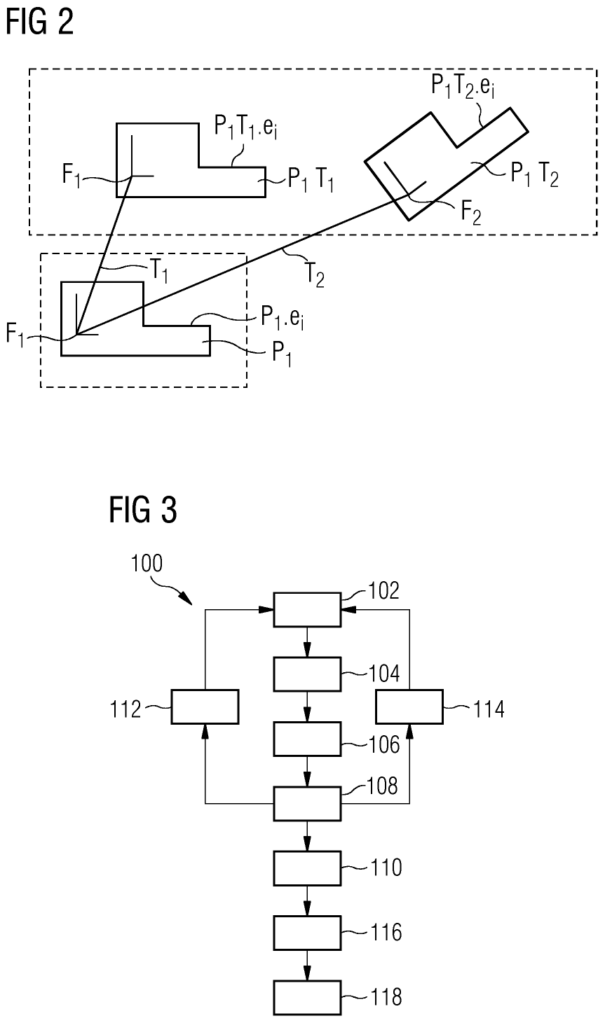

A mechanical design system is assumed to have a representation of each part P in the part's local space and one or more instances of the part P represented in a common global space. The instances of the part P in the common global space are generated by various transforms T of real or implied co-ordinate frames F. This is illustrated further in FIG. 2. FIG. 2 is a schematic illustration of the relationship between a part P in local space and instances of the part P in a common global space. Starting with the local space having a local co-ordinate frame F, a local instance of a first part P1 includes an entity P₁·eᵢ. An instance PᵢTᵢ is defined to be a transformation of a part Pᵢ by a transform T₁ to a co-ordinate frame Fᵢ, such that an entity eᵢ becomes PᵢTᵢ·eᵢ. When a first transform Tᵢ is applied to the part P₁ in order to create an instance of the first part P₁ in a co-ordinate frame F₁, and the entity P₁·eᵢ becomes P₁Tᵢ·eᵢ. Similarly, when a second transform T₂ is applied to the part P₁ in order to create an instance of the first part P₁ in a co-ordinate frame F₂, and the entity P₁·eᵢ becomes P₁T₂·eᵢ. This results in the following instance conditions that need to be maintained as part of the solving operations during the design process:

T₁(P₁·eᵢ)=PᵢTᵢ·eᵢ

T₂(P₁·eᵢ)=P₁T₂·eᵢ

Hence for n instances of the part P₁, the instance conditions may be written as:

Tₙ(P₁·eᵢ)=P₁Tₙ·eᵢ

This is the basis of embodiments described herein. In the following description the shorthand eᵢ is used in place of P·eᵢ for the avoidance of confusion when referring to positioning actions.

FIG. 3 is a flow-chart illustrating a method of modifying instances of at least one part P in a mechanical component design in accordance with an embodiment. The method 100 includes an initial step 102 of obtaining, in its local space, a local instance of a first part P₁ having a local co-ordinate frame F, wherein the part P₁ includes at least one entity eᵢ. At step 104 a transform Tᵢ is applied to the part P₁ to obtain a part instance P₁T₁ having an instance co-ordinate frame F₁ in a common global space. This means that the entity eᵢ is transformed to a corresponding entity P₁T₁·eᵢ in the part instance P₁T₁. At step 106, at least one entity e₁ in the part instance P₁T₁ is marked as a positioning entity pe₁. Grouping the marked positioning entity pe₁ rigidly with the instance co-ordinate frame F₁, wherein any unmarked entities e₁ are not grouped rigidly with the instance co-ordinate frame F₁ occurs at step 108. This grouping activity is fundamental in enabling the simultaneous changing of shape or moving of position of a part and its instances. Causing a positioning entity pe₁ to move in the instance co-ordinate frame F₁ at step 110 causes all positioning entities pe₁ in the instance co-ordinate frame F₁ to move rigidly with the instance co-ordinate frame F₁. However, since they are not marked and grouped rigidly to the co-ordinate frame F1, all of the unmarked entities e₁ move independently of the rigid grouping of positioning entities pe₁.

Similarly, for a second part P₂ having at least one entity e₂, steps 102 to 108 are repeated at step 112. This provides that moving positioning entities peᵢ in either the first part P₁ in its instance co-ordinate frame F₁ or the second part P₂ in its instance co-ordinate frame F₂ causes all of the other positioning entities peᵢ in the respective co-ordinate frame F₁, F₂ to move together in their respective rigid grouping. In other words, if a positioning entity pe₁ in the first part P₁ is moved, all the other positioning entities peᵢ in the first part P₁ are moved in the first co-ordinate frame F₁, but none of the positioning entities peᵢ in the second part P₂ move in the second co-ordinate frame F₂.

One advantage of embodiments is that several instances of the same part may be modified at the same time. At step 114, a transform T₂ is applied to the part P₁ to obtain a part instance P₁T₂ having an instance co-ordinate frame F₂₁ in a common global space, wherein the entity eᵢ is transformed to a corresponding entity e₂₁ in the part instance P₁T₂. At step 116, any entities e₁, e₂, e₂₁ that are not marked as positioning entities pe₁, pe₂, pe₂₁ in the instance co-ordinate frame F₁, F₂ or F₂₁ are marked as modelling entities me₁, me₂, me₂₁. Corresponding unmarked entities eᵢ in the local co-ordinate frame F are also marked as modelling entities meᵢ. The modelling entities meᵢ, me₁, me₂, me₂₁ are not grouped rigidly with their respective co-ordinate frames F, F₁, F₂ or F₂₁. This means that each entity eᵢ that is marked as a modelling entity meᵢ is free to move independently from other modelling entities meᵢ. At step 118, causing one of the modelling entities meᵢ in the local co-ordinate frame F to move or causing one of the modelling entities me₁, me₂, me₂₁ in their respective instance co-ordinate frames F₁, F₂, F₂₁ to move causes all instances of the same entity meᵢ, me₁, me₂, me₂₁ to move in their respective co-ordinate frames F, F₁, F₂, F₂₁. Therefore, a designer may move one modelling entity meᵢ in one co-ordinate frame Fᵢ and all the corresponding modelling entities meᵢ of the same part in all of the other co-ordinate frames Fᵢ will move in the same manner. To enable this to happen, any entity eᵢ, e₁, e₂, e₂₁ connected to the moving modelling entity meᵢ, me₁, me₂, me₂₁ is modified to remain connected to the moving modelling entity meᵢ, me₁, me₂, me₂₁. It is also possible that the positioning entities pe₁, pe₂, pe₂₁ and the modelling entities meᵢ, me₁, me₂, me₂₁ are in different instances of the same part. A single entity cannot be marked as both positioning p and modelling m at the same time, since the rigid grouping and independent movement associated with each marking are mutually exclusive.

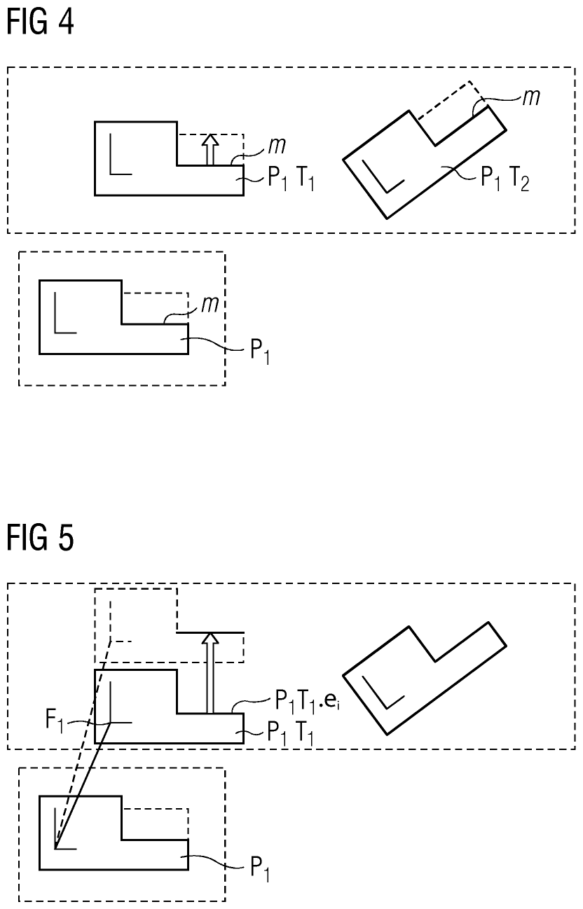

FIG. 4 is a schematic illustration of a modelling action in relation to the part P illustrated in FIG. 2. Initially, an entity, in this example a face of the part P₁ is marked as modelling, m, in the local space co-ordinate frame F. This results in the corresponding face in each instance of the part in the global co-ordinate space also being marked as modelling. In this example, the designer wishes to change the shape of the part P₁ by moving the marked face m to a new position. The designer decides to move the marked face m in the instance of the part P₁ formed by the first transform T₁ in the common global space. Since the marked face m is not grouped rigidly with any other entities in the co-ordinate frame F₁ of the instance, only the marked face m moves, as illustrated by the arrow. Although not shown, faces connected to the marked face m are forced to change to accommodate this move. In addition, since the same face is marked in each instance and in the local instance of the part P₁ the same change occurs in each part instance, regardless of which transform has been used to create it, including the part instance in the local co-ordinate frame F.

FIG. 5 is a is a schematic illustration of a positioning action in relation to the part instance P₁T₁ illustrated in FIG. 2. Here the designer wishes to move an instance of the part P₁ in the global co-ordinate space. This is done by marking the same face as before as positioning, p, in the instance in question. Given that marking the face as positioning p will cause the face to become rigidly grouped with all other entities within the co-ordinate frame F₁, moving the marked face p results in moving the entire part instance P₁T₁. However, none of the other part instances, including the local instance, are affected. The following examples illustrate these concepts in more detail.

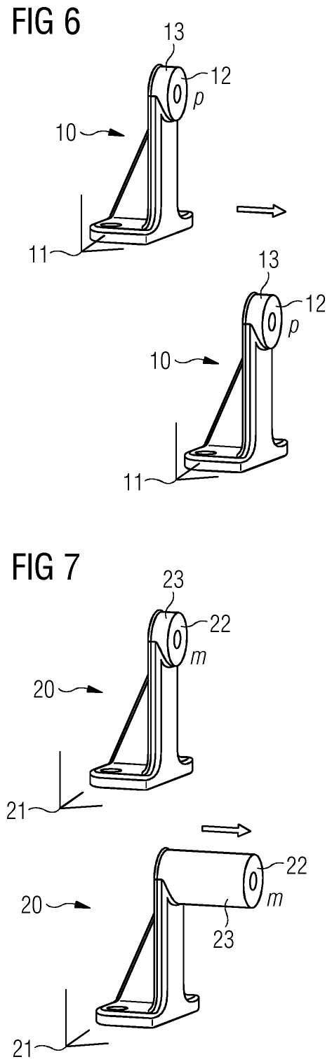

FIG. 6 is a schematic perspective illustration of a positioning action in accordance with embodiments. Initially, a part 10 in a co-ordinate frame 11 has the face 12 of an element 13 marked as positioning p. This results in the face 12 being rigidly grouped within the co-ordinate frame 11, such that when the face 12 is dragged by a designer the whole part 10 moves with the co-ordinate frame 11. FIG. 7 is a schematic perspective illustration of a modelling action in accordance with embodiments. Initially, a part 20 in a co-ordinate frame 21 has the face 22 of an element 23 marked as modelling m. This results in the face 22 not being rigidly grouped within the co-ordinate frame 21, such that when the face 22 is dragged by a designer it is able to move independently within the co-ordinate frame 21. This results in the lengthening of the element 23.

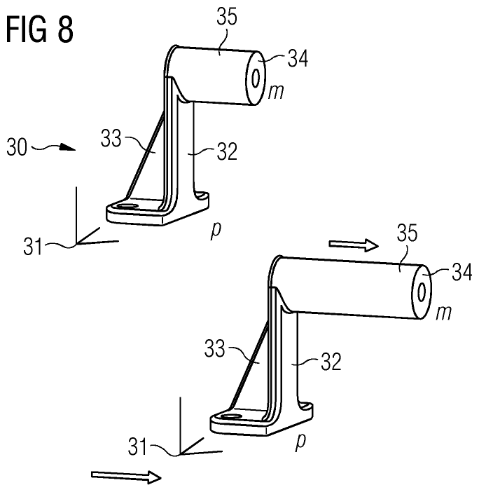

FIG. 8 is a schematic perspective illustration of a positioning action and a modelling action in the same part in a model in accordance with embodiments. Initially, a part 30 in a co-ordinate frame 31 has the face 32 of a first element 33 marked as positioning p. This results in the face 32 being rigidly grouped within the co-ordinate frame 31, such that when the face 32 is dragged by a designer the whole part 30 moves with the co-ordinate frame 31. At the same time, the face 34 of a second element 35 of the same part 30 is marked as modelling m. Since this face 34 is not rigidly grouped within the co-ordinate frame 31 it may be moved, varying the length of the second element 35.

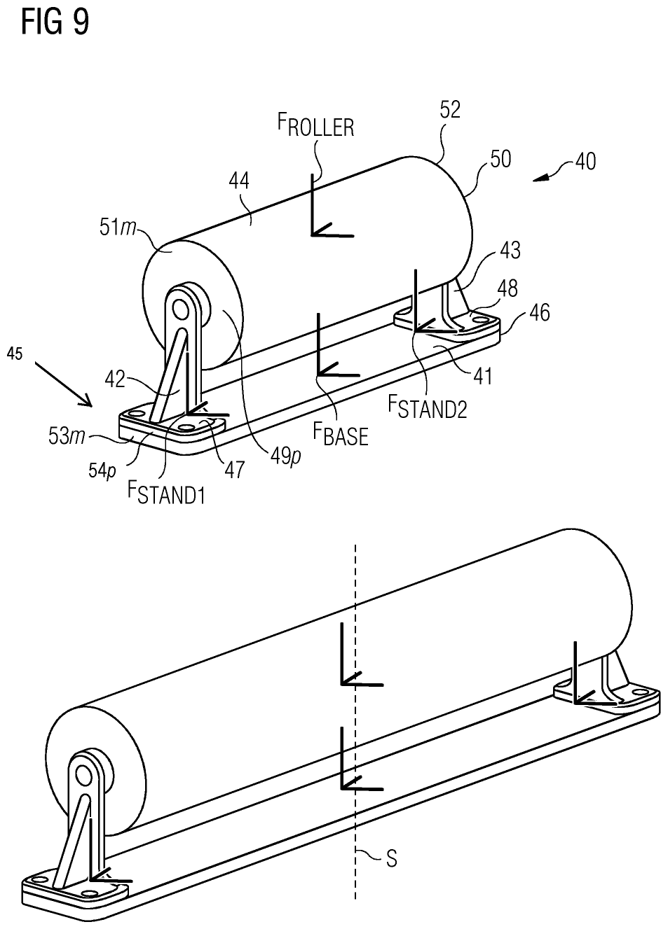

FIG. 9 is a schematic perspective illustration of a positioning action and a modelling action in different parts of a model in accordance with embodiments. The model 40 includes an elongate rectangular base 41, a first stand 42, a second stand 43 and a cylindrical roller 44. The cylindrical roller 44 is supported between the first 42 and second stands 43, that are positioned at opposite ends 45, 46 of the elongate rectangular base 41. Each of the first 42 and second 43 stands is mounted on the elongate rectangular base 41 by a mounting plate 47, 48, and include mating faces 49, 50 between which the cylindrical roller 44 is contained via a first 51 and second 52 roller face. Each of the elongate rectangular base 41, the first stand 42, the second stand 43 and the roller 44 is positioned within its own co-ordinate frame F_{base}, F_{stand 1}, F_{stand 2}, Fᵣₒₗₗₑᵣ, respectively. In order to both move and reposition elements of the model 40, the designer marks the entities appropriately. In this example, the first roller face 51 and the first face 53 of the elongate rectangular base 41 are marked as modelling, m, and the mating face 49 of the first 42 stand, as well as the first face 54 of the mounting plate 47 of the first 42 stand are marked as positioning p.

In order to stretch the cylindrical roller 44, the designer chooses to move the first face 53 of the elongate rectangular base 41. There is an implied symmetry between the ends 45, 46 of the elongate rectangular base 41 around the origin of the co-ordinate frame F_{base}. It is also implied that the base of the first stand 42 and the base of the second stand 43 are coplanar with the elongate rectangular base 41, and that the roller faces 51, 52 are coplanar with the mating faces 49, 50. By moving the first face 53 of the elongate rectangular base 41 both the elongate rectangular base 41 and the cylindrical roller 44 are stretched, since the first face 53 of the base 41 and the first roller face 51 are not rigidly grouped within their respective co-ordinate frames. However, both the mating face 49 and the first face 54 of the first stand 42 are rigidly grouped within their co-ordinate frame F_{stand 1}, resulting in the entire first stand 42 moving without changing shape.

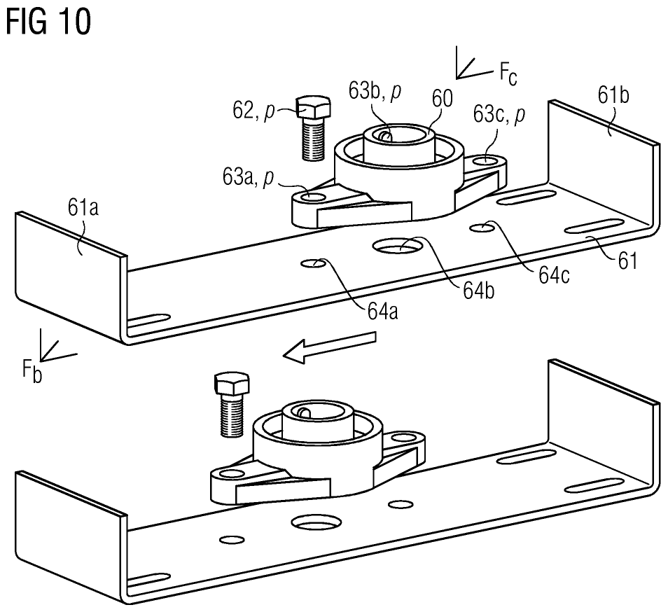

FIG. 10 is a schematic perspective illustration of a further positioning action and a modelling action in different parts of a model in accordance with embodiments. A component 60 and base plate 61 arrangement are connected together by a bolt 62. The base plate 61 has an elongate rectangular shape and is provided with a first end 61a and a second end 61b portion arranged perpendicular to the main body of the base plate 61. The component 60 is provided with first, 63a, second 63b and third 63c through holes, that correspond to coaxial receiving holes 64a, 64b, 64c in the base plate 61. The bolt 62 is sized to fit through one of the first 63a or third 63c through holes and into the corresponding receiving holes 64a, 64c, in order to bolt the component 60 to the base plate 61. This creates an implicit coaxial relationship between the bolt 62 and the first through hole 63a. In this example, the designer desires to move the bolt 62 towards the first end 61a of the base plate 61, that necessitates the change of position of both the component 60 and the receiving holes 64a, 64b, 64c in the base plate 61. To enable this to occur the bolt 62 is marked as positioning p, and the through holes 63a, 63b, 63c are also marked as positioning p. In the case of the through holes 63a, 63b, 63c the marking causes these entities to be grouped rigidly within the co-ordinate frame of the component, F_{c}. From the implicit co-axial relationship between the bolt 62 and the first through hole 63a, the bolt 62 is also effectively grouped rigidly with the entities in the co-ordinate frame of the component F_{c}. The receiving holes 64a, 64b, 64c in the base plate 61 are marked as modelling, meaning that they may move independently of other entities within the co-ordinate frame F_{b} of the base plate 61. However, each of the receiving holes 64a, 64b, 64c has an implicit co-axial relationship with the corresponding through hole 63a, 63b, 63c in the component 60, therefore any re-positioning of a through hole 63a, 63b, 63c will result in the re-positioning of the corresponding coaxial receiving hole 64a, 64b. 64c in order to maintain the implicit co-axial relationship. Moving the bolt 62 in the direction of the arrow towards the first end 61a of the base plate 61 therefore causes not only the bolt 62 to move, but also the component 60 and the receiving holes 64a, 64b, 64c in the base plate 61 to move as well, whilst maintaining the co-axial relationships with the through holes 63a, 63b, 63c in the component 60.

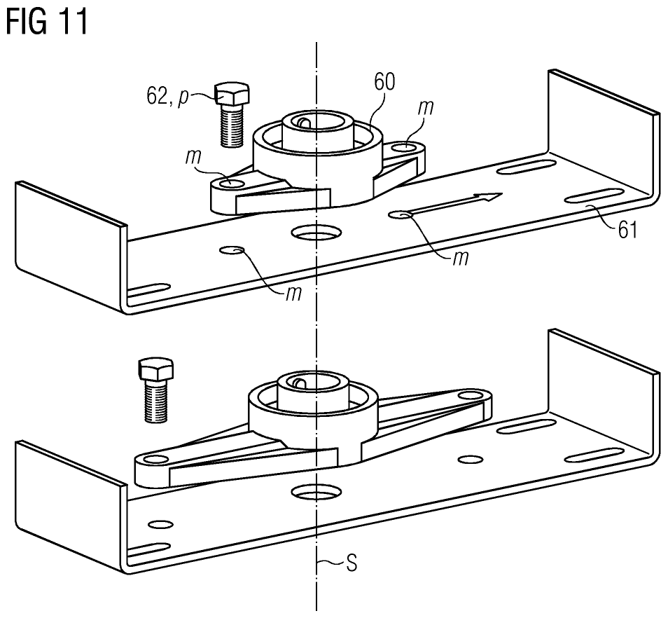

FIG. 11 is a schematic perspective illustration of a further positioning action and a modelling action in different parts of a model in accordance with embodiments. Taking the same arrangement as in FIG. 10 above, in this example the inherent symmetry in the model is also relevant for carrying out simultaneous positioning and modelling actions. Unlike in FIG. 10, in FIG. 11 whilst the bolt 62 is marked as positioning p, the first 63a and third 63c through holes in the component 60 are marked as modelling m. In addition, the corresponding co-axial receiving holes 64a, 64c are also marked as modelling m. Again, there is an inherent co-axial relationship between the bolt 62 and the first through hole 63a, as well as between the first 63a and third 63c through holes and co-axial receiving holes 64a, 64c respectively. However, in this example, there is an additional reflection symmetry about a central perpendicular plane S that is orthogonal to both the component 60 and the base plate 61, effectively dividing each into two. This creates a local implied symmetry in the component 60, such that when the third co-axial receiving hole 64c is moved towards the second end 61b of the base plate 61 the following actions occur: the third through hole 63c moves with the third co-axial receiving hole 64c due to their implied co-axial relationship; the implied symmetry within the component 60 causes the first through hole 63a to move in an equal and opposite manner; the first co-axial receiving hole 64a also moves in an equal an opposite manner to the third co-axial through hole 64c due to its implied co-axial relationship with the first through hole 63a; the entire bolt 62 moves within its frame of reference to maintain the implied co-axial relationship with the first through hole 63a. To accommodate the various positioning changes the component 60 stretches since the through holes 63a, 63c are not rigidly grouped within the component co-ordinate frame F_{c}. The entities in contact or axially aligned with the through holes 63a, 63c are also modified in order to remain connected or aligned to the through holes 63a, 63c. In addition, the through holes 63a, 63c are axially aligned with the outer cylinder of the part 60, that is in turn tangent connected with the planar walls housing the through holes 63a, 63c.

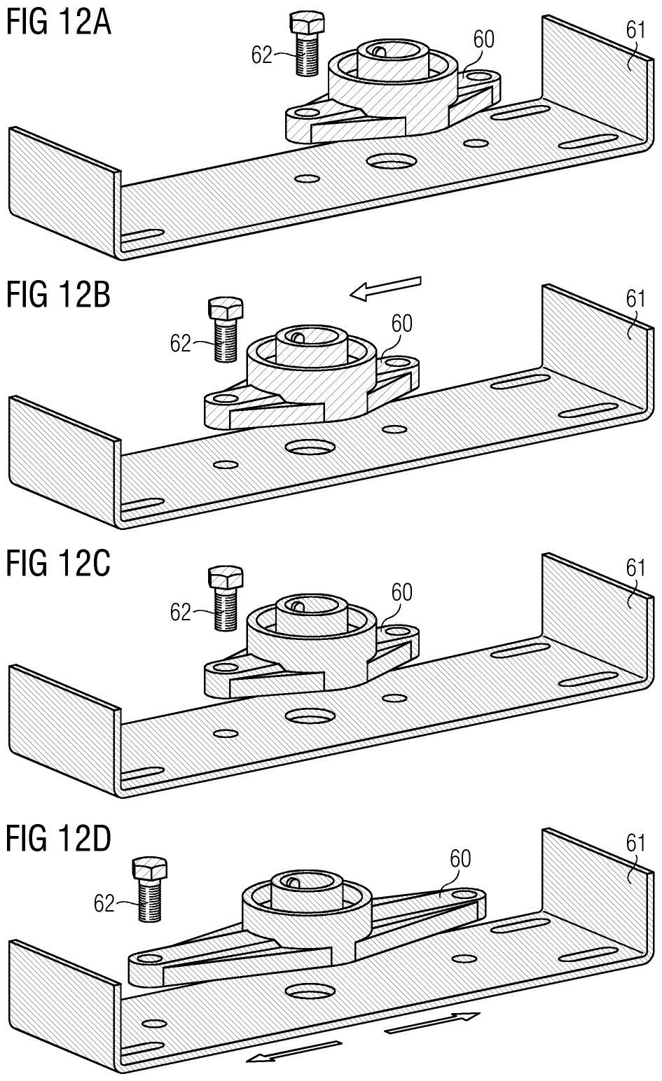

FIG. 12 is a schematic perspective illustration of the modification of different parts of a model in accordance with further embodiments.

FIG. 12 represents a simplification of the method illustrated in FIG. 3, where rather than marking individual entities within parts or part instances as positioning p or modelling m to enable a designer to undertake both positioning and modelling actions in each part at the same time, all entities of interest in a part are only marked either as positioning p or modelling m, such that effectively a single mode of operation is created for each part: for each part, either the designer causes positioning actions or modelling actions, but not both at the same time in the same part. This extends the concept that a single entity cannot be marked as both positioning p and modelling m at the same time, due to rigid grouping and independent movement being mutually exclusive. Therefore, entities e in a part P are either all marked as positioning entities pe or all marked as modelling entities me, and wherein all the entities e are changed between being marked as positioning entities pe or all marked as modelling entities me simultaneously.

FIG. 12a depicts a schematic perspective view of the component 60, base plate 61 and bolt 62 arranged as described above with respect to FIG. 10. Initially, the component 60 and bolt are marked as positioning p, and the base plate 61 is marked as modelling m. In the figure, left-to-right cross-hatching is used to represent positioning p and right-to-left cross-hatching is used to represent modelling m, however in use the different markings may be represented to a designer by different colors on a display. As above, moving the bolt 62 causes the component 60 to move, since both are marked as positioning p, as illustrated in FIG. 12b. Since the same implied co-axial relationships still apply, the co-axial through holes 64a, 64b, 64c in the base plate 61 move to maintain this relationship with the through holes 63a, 63b, 63c in the component 60. This is the same situation as illustrated in FIG. 10 above. At this point the designer changes the mode of the component 60 from positioning to modelling, as illustrated in FIG. 12c. The implied mirror symmetry along with the inherent co-axial relationships of the through holes 63a, 63b, 63c in the component 60 and the receiving holes 64a, 64b, 64c in the base plate 61, creates the symmetric editing illustrated in FIG. 12d and as described with respect to FIG. 11 above, where the third receiving hole 64c is moved and the component 60 stretches in a symmetric manner to accommodate this.

In the above examples, the designer is able to choose how to label entities in parts and part instances, that in practice may be done by a menu choice, drop box or other indicator in a GUI. However, it may be desirable to use heuristic techniques to aid the marking, either to make marking multiple part instances or complex parts easier or to prevent alteration of certain components. For example, it is highly likely that the bolt in the above examples will only ever be marked as positioning p, hence this could be set permanently, and the designer not given an option to change the marking to modelling m. Alternatively, in certain models the mode (positioning p or modelling m) may be determined by particular faces or vertices, that are known to be drivers of change. It is also possible to extend the marking of entities as positioning p to both assemblies and sub-assemblies of parts, enabling changes in position to be replicated at any point in an assembly tree in a hierarchical modelling structure.

Aspects also include a data processing system including a processor configured to carry out the methods of embodiments as described above. Such a data processing system includes the processor, a RAM, access to data storage by the processor (either a local memory or server file access, or access to cloud computing storage, a display or graphical user interface and an input for a designer, such as a touchscreen, keyboard and/or mouse.

In order to carry out the methods of the embodiments described above, a computer program includes instructions, that when executed by the processor cause the processor to carry out the steps of the methods.

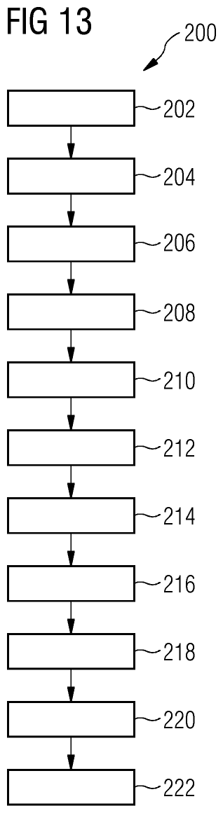

FIG. 13 is a flow-chart illustrating an implementation of embodiments within a solver. The implementation method 200 is carried out on a data processing system, with the first step 202 being to form a solver representation of the local co-ordinate frame F and entities eᵢ for each part P. Next, at step 204, a copy of the entities eᵢ and co-ordinate frame Fᵢ for each part instance is created, and at step 206 these are each transformed via an appropriate transform T₁ to the correct position within the common global space, creating a part instance PᵢTᵢ. At step 208, the transforms Tᵢ are used to form a solver representation of a transform matrix, that is used to constrain the part instances PᵢTᵢ to the relative part P. A rigid constraint for each part instance PᵢTᵢ co-ordinate frame Fᵢ is formed at step 210, with the co-ordinate frame Fᵢ and any positioning entities pe₁ within the part instance PᵢTᵢ added to the constraint. At step 212 any persistent or inferred constraints between the part instances PᵢTᵢ within the common global space are added to the solver, and at step 214 any persistent or inferred constraints between entities eᵢ in the part P are also added to the solver. Input drivers, such as co-ordinate frame drag operations, entity drag operations, dimension edits and other actions are added to the solver at step 216. The system is solved at step 218, and any changed transform constraints in the common global space that have been changed are applied at step 220. Finally, any local entity eᵢ position changes to the part P are applied, and depending on the representation, applied similarly to each part instance PᵢTᵢ at step 222.

It is to be understood that the elements and features recited in the appended claims may be combined in different ways to produce new claims that likewise fall within the scope of the present embodiments. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present embodiments have been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of modifying instances of at least one part in a mechanical component design, wherein each part comprises at least one entity, the method comprising:
obtaining, in a local space of a first part, a first local instance of the first part having a first local co-ordinate frame, wherein the first part comprises the at least one entity;
Applying a first transform to the first part to obtain a second part instance having a second instance co-ordinate frame in a common global space, wherein the at least one entity is transformed to at least one corresponding entity in the second part instance;
marking the at least one corresponding entity in the second part instance as a positioning entity; and
grouping the positioning entity rigidly with the second instance co-ordinate frame wherein any unmarked entities are not grouped rigidly with the second instance co-ordinate frame, such that causing the positioning entity to move in the second instance co-ordinate frame causes all positioning entities in the second instance co-ordinate frame to move rigidly with the second instance co-ordinate frame and all of the unmarked entities to move independently of the rigid grouping of positioning entities.

2. The computer-implemented method of claim 1, further comprising:
repeating obtaining, applying, marking, and grouping for a second part having at least one second entity, such that moving positioning entities in either the first part in the second instance co-ordinate frame or the second part in a third instance co-ordinate frame causes all of the other positioning entities in in a respective co-ordinate frame to move together in a respective rigid grouping.

3. The computer-implemented method of claim 1, further comprising:
applying a second transform to the first part to obtain a part instance having a part instance co-ordinate frame in a common global space, wherein the entity is transformed to a corresponding entity in the part instance.

4. The computer-implemented method of claim 2, wherein any entities that are not marked as positioning entities in a respective instance co-ordinate frame are marked as modelling entities and wherein corresponding unmarked entities in the first local co-ordinate frame are marked as modelling entities.

5. The computer-implemented method of claim 4, wherein the modelling entities are not grouped rigidly with their respective co-ordinate frames.

6. The computer-implemented method of claim 4, wherein causing one of the modelling entities in the first local co-ordinate frame to move or causing one of the modelling entities in their respective instance co-ordinate frames to move causes all instances of the same modelling entity to move in their respective co-ordinate frames.

7. The computer-implemented method of claim 6, wherein any entity connected to the moving modelling entity is modified to remain connected to the moving modelling entity.

8. The computer-implemented method of claim 4, wherein the positioning entities and the modelling entities are in different instances of the same part.

9. The computer-implemented method of claim 1, wherein an assembly positioning of the first part and second part takes place in the common global space.

10. The computer-implemented method of claim 1, wherein the first part and second part are sub-assemblies in an assembly tree.

11. The computer-implemented method of claim 3, wherein instance conditions maintained during positioning and modelling are defined as:
T₁(P₁·eᵢ)=P₁T₁e₁
T₂(P₁·eᵢ)=P₁T₂e₂,
wherein T₁ is the first transform, wherein T₂ is the second transform; wherein eᵢ is the at least one entity, wherein P₁ is the first part, e₁ is the at least one entity of the first part, and e₂ is the at least one entity of the first part.

12. The computer-implemented method of claim 3, wherein implied symmetry, inherent entity relationships, or implied symmetry and inherent entity relationships are maintained during positioning and modelling.

13. The computer-implemented method of claim 1 wherein the at least one entities in a part are either all marked as positioning entities or all marked as modelling entities, and wherein all the entities are changed between being marked as positioning entities or all marked as modelling entities me simultaneously.

14. (canceled)

15. (canceled)

16. A non-transitory computer implemented storage medium that stores machine-readable instructions for modifying instances of at least one part in a mechanical component design, wherein each part comprises at least one entity, the machine-readable instructions executable by at least one processor, the machine-readable instructions comprising:
obtaining, in a local space of a first part, a first local instance of the first part having a first local co-ordinate frame, wherein the first part comprises the at least one entity;
applying a first transform to the first part to obtain a second part instance having a second instance co-ordinate frame in a common global space, wherein the at least one entity is transformed to at least one corresponding entity in the second part instance;
marking the at least one corresponding entity in the second part instance as a positioning entity; and
grouping the positioning entity rigidly with the second instance co-ordinate frame wherein any unmarked entities are not grouped rigidly with the second instance co-ordinate frame, such that causing the positioning entity to move in the second instance co-ordinate frame causes all positioning entities in the second instance co-ordinate frame to move rigidly with the second instance co-ordinate frame and all of the unmarked entities to move independently of the rigid grouping of positioning entities.
